(19) United States
(12) Patent Application Publication
(10) Pub. No.: US 2013/0272650 A1
(43) Pub. Date: Oct. 17, 2013

(54) WAVELENGTH CROSS CONNECT DEVICE

(71) Applicants: National Institute of Advanced Industrial Science and Technology, (US); HITACHI CABLE, LTD., Tokyo (JP); KEIO UNIVERSITY, Tokyo (JP)

(72) Inventors: Hiroshi Ishikawa, Tsukuba (JP); Toshifumi Hasama, Tsukuba (JP); Hitoshi Kawashima, Tsukuba (JP); Masahiko Mori, Tsukuba (JP); Hisato Uetsuka, Tsukuba-shi (JP); Akihito Hongo, Tsuchiura (JP); Hiroyuki Tsuda, Yokohama (JP); Keisuke Sorimoto, Yokohama (JP); Nazirul Afham bin Idris, Yokohama (JP)

(73) Assignees: National Institute of Advanced Industrial Science and Technology, Tokyo (JP); KEIO UNIVERSITY, Tokyo (JP); HITACHI CABLE, LTD., Tokyo (JP)

(21) Appl. No.: 13/850,189

(22) Filed: Mar. 25, 2013

(30) Foreign Application Priority Data
Apr. 11, 2012 (JP) 2012-090182

(51) Int. Cl. G02B 6/35

(52) U.S. Cl. CPC G02B 6/35
USPC 385/17

(57) ABSTRACT

A wavelength cross connect device includes an input demultiplexing optical system for demultiplexing light input from a plurality of input ports into respective wavelengths, a wavelength switching optical system for switching and outputting the lights of respective wavelengths input from the input demultiplexing optical system to respective desired ports, and an output multiplexing optical system for multiplexing the lights of respective wavelengths input from the wavelength switching optical system per port. The input demultiplexing optical system and the output multiplexing optical system includes a lens system that has a function of focusing lights independently in vertical and widthwise directions. The wavelength switching optical system includes two light deflector arrays for outputting incoming light of each wavelength after adjusting a horizontal reflection angle of the light, and a switching lens including a lens that has a focal length equal to the Rayleigh length and acts only in a widthwise direction.

The present application is based on Japanese patent application No. 2012-090182 filed on Apr. 11, 2012, the entire contents of which are incorporated herein by reference.

### BACKGROUND OF THE INVENTION

1. Field of the Invention

The invention relates to a wavelength cross connect device.

2. Description of the Related Art

A wavelength cross connect device shown in FIG. 14 is conventionally known (see Patent Literature 1).

A wavelength cross connect device 141 shown in FIG. 14 is composed of an input optical fiber 142, an output optical fiber 143, microlens arrays 144, macro-lens pairs 145, gratings 146, λ/4 plates 147 and an optical switch matrix 148.

In the wavelength cross connect device 141, light input from the input optical fiber 142 passes through the microlens array 144 and a macro-lens 145a as one of macro-lenses constituting the macro-lens pair 145, and is demultiplexed into each wavelength by the grating 146. The lights of respective wavelength demultiplexed by the grating 146 pass through a macro-lens 145b as another macro-lens constituting the macro-lens pair 145 and the λ/4 plates 147 and are then incident on the optical switch matrix 148.

The optical switch matrix 148 is formed by oppositely arranging plural MEMS minors 149 and is configured so that each wavelength can be switched by changing a reflection angle of the MEMS mirrors 149. The lights output from the optical switch matrix 148 pass through the λ/4 plate 147 and the macro-lens 145b and are then multiplexed by the grating 146, and the multiplexed light passes through the macro-lens 145a and the microlens array 144 and is then output from the output optical fiber 143.

Meanwhile, as an optical cross connect device for switching single-wavelength light, there is a device shown in FIG. 15 even though it is not a wavelength cross connect device (see Non-Patent Literature 1).

In an optical cross connect device 151, MEMS mirror arrays 152 are oppositely arranged, and a lens 153 lens with a focal length equal to the Rayleigh length is arranged between the two MEMS mirror arrays 152. Distances between the both MEMS mirror arrays 152 and the lens 153 are adjusted to be respectively equal to a focal length (i.e., the Rayleigh length) of the lens 153.

In the optical cross connect device 151, light input from an input-side fiber array 154 is input to one MEMS mirror array 152 through a lens array 155, is reflected by the one MEMS mirror array 152, passes through the lens 153, is then further reflected by another MEMS mirror array 152 and is output from an output-side fiber array 156 via another lens array 155. Here, since the lens 153 converts an angle into a position (offset), change of reflection angle by the one MEMS mirror array 152 is reflected as change of a position on the other MEMS mirror array 152 and switching is thereby carried out.

Meanwhile, another conventionally known wavelength cross connect device is shown in FIG. 17A. In the wavelength cross connect device 171 shown in FIG. 17A, a signal light input from one fiber of input/output fiber array 172 is shaped by a polarization diversity optical system 173 and a condenser lens 174, passes through a focal point C of the condenser lens 174, is then collimated by a curved mirror 175 and is demultiplexed into each wavelength at a point G on a grating 176. The demultiplexed signal light is focused onto an LCOS 177 at a point A by the curved mirror 175. The focal position is a different position on a λ-axis of the drawing depending on the wavelength. The LCOS 177 independently modulates the phases of the respective wavelengths. The phase-modulated light is freely deflected and reflected in a depth direction of paper face (Y-axis direction). The light reflected at the point A passes through the curved mirror 175, is multiplexed at a point G′ on the grating 176 and reaches a Fourier mirror 178 via the curved mirror 175, the focal point C and the condenser lens 174. The light reflected by the Fourier mirror 178 travels back on the same optical path as the incoming path as viewed from the top and is output to the input/output fiber array 172.

FIG. 17B shows such an operation as viewed from a side (a Y-Z axis plane) (in order to simplify the explanation, the elements other than the LCOS 177 and the Fourier mirror 178 are omitted). An appropriate setting of the reflection angle at the point A on the LCOS 177 allows the light reflected by the Fourier mirror 178 to reach a point B which is another position on a surface of the LCOS 177. The phase is modulated again at the point B and a deflection angle of the light is adjusted so as to be coupled to a desired output fiber of the input/output fiber array 172. Appropriate settings of the positions of the points A and B on the Y-axis and the deflection angle at each position allows switching from a given input fiber to a given output fiber of the input/output fiber array 172 in any combination. In other words, in one switching operation of the wavelength cross connect device 171, the optical path follows the points C-G-A-G′-C-C-G′-B-G-C in this sequence and passes through the grating 176 four times in total.

Patent Literature 1: U.S. Pat. No. 6,289,145, Specification

Non-Patent Literature 1: David T. Neilson and eleven others, “256×256 Port Optical Cross-Connect Subsystem”, JOURNAL OF LIGHTWAVE TECHNOLOGY, Vol. 22, No. 6, p. 1499-1509, April 2004

Non-Patent Literature 2: Nicolas K. Fontaine and two others, “N×M WAVELENGTH SELECTIVE CROSSCONNECT WITH FLEXIBLE PASSBANDS” OFC/NFOEC POSTDEADLINE PAPERS, PDP5B.2, March 2012

### SUMMARY OF THE INVENTION

However, in the conventional wavelength cross connect device 141 shown in FIG. 14, since a normal two-dimensional lens is used as the microlens array 144 or the macro-lens pair 145, light distribution on the MEMS mirror 149 is an enlarged image of outgoing light from the input optical fiber 142, resulting in a circular light distribution. Accordingly, the MEMS mirror 149 having a very large area is required in order to realize flat-top response (flattening of wavelength passband) and low crosstalk which are requirements of optical communication system. However, this makes difficult to provide multiple ports and also causes problems of an increase in drive voltage and flatness of mirror, hence it is difficult to realize those requirements.

In addition, in the wavelength cross connect device 141, the image on the MEMS mirror 149 does not become a beam waist (a focal point in which a size of image is minimized) but becomes a large image since a space between the oppositely arranged MEMS mirrors 149 is a free space, and accordingly, the MEMS mirror 149 having a larger area is required. Therefore, it is very difficult to provide multiple ports in the wavelength cross connect device 141.

In the optical cross connect device 151 of FIG. 15, the image on the MEMS mirror is a beam waist since the lens 153 with a focal length equal to the Rayleigh length is provided between the facing MEMS mirror arrays 152, which allows the area of the MEMS mirror to be reduced. Therefore, integration is easy and it is advantageous to provide multiple ports.

However, it is difficult to apply the optical cross connect device 151 to a wavelength cross connect device since switching per wavelength is not taken into consideration at all and a normal two-dimensional lens is used as the lens 153. In detail, in order to realize a wavelength cross connection in the optical cross connect device 151, the number of spectrograph-demultiplexers 161 to be connected needs to be the same as the number of input/output ports to multiplex and demultiplex wavelengths as shown in FIG. 16, which results in a huge device as well as the high cost.

The wavelength cross connect device 171 adopts an optical system which passes through the grating 176 four times in total, as described above. However, reflectance of each time is poor since the grating 176 has inherent loss such as unnecessary order of diffractive excitation, and passing through the grating 176 four times makes insertion loss of the wavelength cross connect device 171 significantly worse.

Accordingly, it is an object of the invention to provide a wavelength cross connect device that allows low loss, flat-top response, low crosstalk and multiport to be realized and has a simple and low-cost structure.
(1) According to one embodiment of the invention, a wavelength cross connect device comprises:

an input demultiplexing optical system that demultiplexes light input from a plurality of input ports into respective wavelengths and outputs the demultiplexed lights;

a wavelength switching optical system for switching and outputting the lights of respective wavelengths input from the input demultiplexing optical system to respective desired ports; and

an output multiplexing optical system that multiplexes the lights of respective wavelengths input from the wavelength switching optical system per port and outputs the multiplexed lights through corresponding output ports,

wherein the input demultiplexing optical system and the output multiplexing optical system are configured such that optical paths of the lights from the respective ports are aligned in parallel to each other in a widthwise direction and light from each port is demultiplexed or multiplexed in a vertical direction, and comprise a lens system that has a function of focusing lights independently in vertical and widthwise directions so as to focus the light of each wavelength output to the wavelength switching optical system into a horizontal oval shape or so as to convert the horizontal oval-shaped focal point of the light of each wavelength input from the wavelength switching optical system back into a focal point having the same shape as an image of the output port, and

wherein the wavelength switching optical system comprises:

two light deflector arrays being oppositely arranged at respective focal positions of the lens systems of the input demultiplexing optical system and the output multiplexing optical system and comprising two-dimensional light deflection elements vertically and horizontally arranged so as to correspond to the light of each wavelength of each port to output incoming light of each wavelength after adjusting a horizontal reflection angle of the light; and

a switching lens comprising a lens that has a focal length equal to the Rayleigh length and acts only in a widthwise direction, being arranged between the two light deflector arrays so that respective distances from the two light deflector arrays are both equal to the focal length to perform switching by converting the horizontal angle of the light of each wavelength adjusted by one of the light deflector arrays into a horizontal position on another light deflector array.

In the above embodiment (1) of the invention, the following modifications and changes can be made.

(i) The wavelength switching optical system comprises multi-stage Fourier optical lenses acting only in a vertical direction and is configured to convert a vertical angle into a vertical position and subsequently convert the vertical position back into the vertical angle by the multi-stage lenses.

(ii) The input demultiplexing optical system and the output multiplexing optical system comprise:

waveguide arrays being formed by monolithically integrating a plurality of channel waveguides formed on a flat substrate so as to have a structure having a high refractive index core covered with a low refractive index cladding such that input/output ports on one side of the channel waveguides are used as the input ports or the output ports and input/output ports on another side are aligned in a straight line in a widthwise direction; and

a demultiplexing element vertically demultiplexing the light of each port emitted from the input/output port on the other side of the waveguide array into each wavelength and then outputting the demultiplexed lights to the wavelength switching optical system or multiplexing the light of each wavelength input from the wavelength switching optical system and then making the multiplexed light incident on the input/output port on the other side of the waveguide array, and

wherein the lens system comprises:

a first lens comprising a lens acting only in a vertical direction to collimate the light emitted from the input/output port on the other side of the waveguide array and then output the collimated light to the demultiplexing element or to focus the light input from the demultiplexing element and then make the focused light incident on the input/output port on the other side of the waveguide array;

a second lens comprising a lens acting only in a vertical direction to focus the light of each wavelength demultiplexed by the demultiplexing element and then output the focused light to the wavelength switching optical system or to focus the light of each wavelength input from the wavelength switching optical system and output the focused light to the demultiplexing element; and

a third lens comprising a lens acting only in a widthwise direction and being separately provided in each of the input/output ports on the other side of the waveguide arrays.

(iii) An enlarged-waveguide portion is formed on each of the channel waveguides of the waveguide array, the enlarged-waveguide portion being formed by enlarging the core toward the input/output port on the other side as viewed from the top by using a tapered waveguide or a slab waveguide, and the third lens comprises a bulk cylindrical lens array provided in the vicinity of an output port of the enlarged-waveguide portion.

(iv) An enlarged-waveguide portion is formed on each of the channel waveguides of the waveguide array, the enlarged-waveguide portion being formed by enlarging the core toward the input/output port on the other side as viewed from the top by using a tapered waveguide or a slab waveguide, and the third lens comprises a waveguide lens formed on the core enlarged by the enlarged-waveguide portion of each of the channel waveguides or on a cladding in the vicinity of the enlarged core.

(v) The waveguide lens is formed by filling a cladding material or a resin having a lower refractive index than the core into a plurality of trenches formed by vertically trenching the core of each of the channel waveguides so that the total width of trenches forms a lens shape or Fresnel lens shape that is concave with respect to a light propagation direction as viewed from the top.

(vi) A resin having a lower refractive index than the cladding is used as the resin having a lower refractive index than the core.

(vii) The waveguide lens is formed by filling a resin having a higher refractive index than the core into a plurality of trenches formed by vertically trenching the core of each of the channel waveguides so that the total width of trenches forms a lens shape or Fresnel lens shape that is convex with respect to a light propagation direction as viewed from the top.

(viii) The plurality of trenches are formed so as to be unequally spaced in a light propagation direction.

(ix) The channel waveguides of the waveguide array each comprise a bent portion formed by bending the core.

(x) An optical fiber array comprising a plurality of optical fibers arranged in an array manner is connected to the input/output ports on the one side of the waveguide array.

(xi) The demultiplexing element comprises a grating having ruled line formed in a widthwise direction.

(xii) The grating comprises a reflective blazed grating or a reflective echelle grating or a grism comprising a grating and a prism coating a surface thereof

(xiii) The light deflector array is formed by arranging a plurality of strip-shaped one-dimensional MEMS mirror groups in a widthwise direction in an array manner so as to correspond to each port, the plurality of one-dimensional MEMS mirror groups each comprising a plurality of MEMS mirrors one-dimensionally arranged in a vertical direction.

(xiv) The MEMS mirrors are each configured such that an interval in an array direction thereof corresponds to a signal frequency interval of not more than 12.5 GHz and a gap between the adjacent MEMS mirrors is set to not more than a spot-size of the incoming light.

(xv) The one-dimensional MEMS mirror group is formed by grouping a plurality of the MEMS mirrors so that the grouped MEMS mirrors are controlled to be inclined at the same angle.

(xvi) The light deflector array is formed by arranging a plurality of LCOS chips in a widthwise direction in an array manner so as to correspond to each port.

(xvii) The light deflector array comprises an LCOS chip in one-piece and is configured such that the oval-shaped focal point group corresponding to all operating wavelengths output from each port falls within an effective diameter of the LCOS chip.

(xviii) The LCOS chip comprises a ¼ wavelength layer formed between a liquid crystal layer and a reflective film.

### Effects of the Invention

According to one embodiment of the invention, a wavelength cross connect device can be provided that allows low loss, flat-top response, low crosstalk and multiport to be realized and has a simple and low-cost structure.

### BRIEF DESCRIPTION OF THE DRAWINGS

Next, the present invention will be explained in more detail in conjunction with appended drawings, wherein:

FIG. 1 is a perspective view showing a wavelength cross connect device in an embodiment of the present invention;

FIGS. 2A and 2B are diagrams illustrating an input demultiplexing optical system of the wavelength cross connect device of FIG. 1, wherein FIG. 2A is a side view and FIG. 2B is a top view;

FIGS. 3A to 3F are explanatory diagrams illustrating a waveguide lens used in the wavelength cross connect device of FIG. 1 and FIG. 3G is an explanatory diagram illustrating a cylindrical lens array;

FIGS. 4A and 4B are diagrams illustrating an output multiplexing optical system of the wavelength cross connect device of FIG. 1, wherein FIG. 4A is a side view and FIG. 4 is a top view;

FIGS. 5A and 5B are diagrams illustrating a wavelength switching optical system of the wavelength cross connect device of FIG. 1, wherein FIG. 5A is a side view and FIG. 5B is a top view;

FIGS. 6A to 6C are diagrams illustrating a MEMS array used in the wavelength cross connect device of FIG. 1, wherein FIG. 6A is a perspective view, FIG. 6B is a perspective view showing a one-dimensional MEMS mirror group and FIG. 6C is a perspective view showing the one-dimensional MEMS mirror group in which plural MEMS mirrors are grouped;

FIGS. 7A to 7D are diagrams illustrating light switching operation of each port in the wavelength cross connect device of FIG. 1;

FIG. 8 is a perspective view showing a wavelength cross connect device in another embodiment of the invention;

FIG. 9 is a perspective view showing a wavelength cross connect device in another embodiment of the invention;

FIG. 10 is a perspective view showing a wavelength cross connect device in another embodiment of the invention;

FIGS. 11A to 11E are diagrams illustrating an LCOS chip array used in the invention, wherein FIG. 11A is a perspective view, FIG. 11B is a plan view of the LCOS chip, FIG. 11C is a cross sectional view of the LCOS chip, FIG. 11D is a diagram illustrating an example of refractive-index distribution on the LCOS chip and FIG. 11E is a perspective view when using an LCOS chip in one-piece;

FIG. 12 is an explanatory diagram illustrating multicast operation when the LCOS chip array is used in the invention;

FIG. 13A is a schematic configuration diagram illustrating a node device using the wavelength cross connect device of the invention and FIG. 13B is a schematic configuration diagram illustrating a node device using a conventional wavelength cross connect device;

FIG. 14 is a schematic configuration diagram illustrating a conventional wavelength cross connect device;

FIG. 15 is a schematic configuration diagram illustrating a conventional optical cross connect device;

FIG. 16 is a perspective view illustrating the case where the conventional optical cross connect device of FIG. 15 is used as a wavelength cross connect device; and

FIGS. 17A and 17B are schematic configuration diagrams illustrating a conventional wavelength cross connect device, wherein FIG. 17A is a top view and FIG. 17B is a side view.

### DETAILED DESCRIPTION OF THE PREFERRED EMBODIMENTS

An embodiment of the invention will be described below in conjunction with the appended drawings.

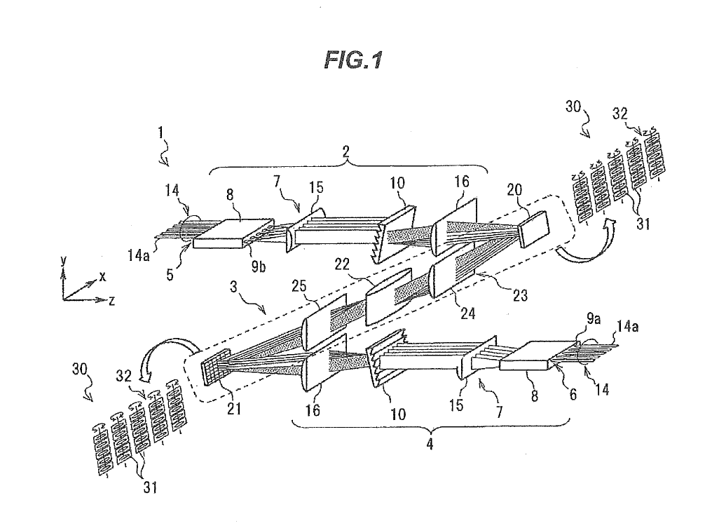

FIG. 1 is a perspective view showing a wavelength cross connect device in the present embodiment.

As shown in FIG. 1, a wavelength cross connect device 1 is provided with an input demultiplexing optical system 2 which demultiplexes light input from plural input ports 5 into respective wavelengths and outputs the demultiplexed lights, a wavelength switching optical system 3 for switching and outputting the lights of respective wavelengths input from the input demultiplexing optical system 2 to respective desired ports, and an output multiplexing optical system 4 which multiplexes the lights of respective wavelengths input from the wavelength switching optical system 3 per port and outputs the multiplexed lights through corresponding output ports 6.

The wavelength switching optical system 3 optically couples two optical systems, the input demultiplexing optical system 2 and the output multiplexing optical system 4, and serves to switch the lights of respective wavelengths from the respective ports to the desired ports.

Although FIG. 1 shows the five-input five-output (5×5) wavelength cross connect device 1 which has five input ports 5 and five output ports 6, the number of inputs/outputs is not limited thereto. In addition, although the case of transmitting five optical signals with different wavelengths through one port is described in FIG. 1, the number of wavelengths used per port is not limited thereto.

The input demultiplexing optical system 2, the output multiplexing optical system 4 and the wavelength switching optical system 3 will be described in detail below in this order.

Input Demultiplexing Optical System

Firstly, the input demultiplexing optical system 2 will be described.

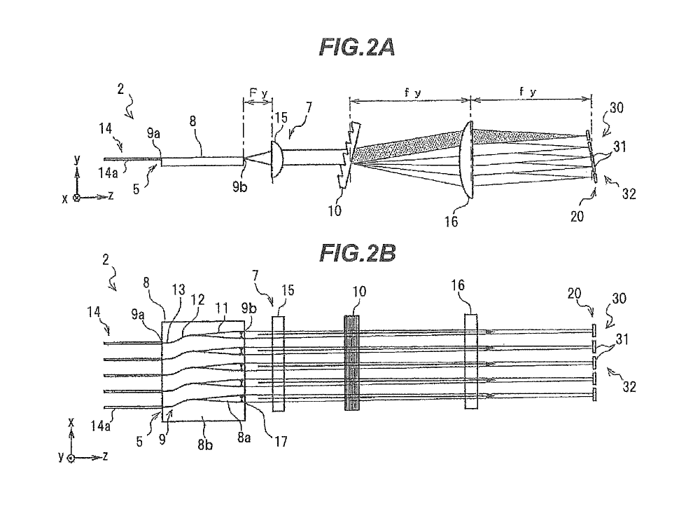

As shown in FIGS. 1 to 2B, the input demultiplexing optical system 2 is configured such that optical paths of the lights from the respective ports are aligned in parallel to each other in a widthwise direction (X-axis direction) and light from each port is demultiplexed in a vertical direction (Y-axis direction). And also, the input demultiplexing optical system 2 is provided with a lens system 7 which has a function of independently focusing lights in vertical and widthwise directions so that the light of each wavelength output to the wavelength switching optical system 3 is focused into a horizontal oval shape.

In more detail, the input demultiplexing optical system 2 is composed of a waveguide array 8, a grating 10 as a demultiplexing element and the lens system 7.

The waveguide array 8 is formed by monolithically integrating plural channel waveguides 9 formed on a non-illustrated flat substrate and has a structure in which high refractive index cores 8a are covered with a low refractive index cladding 8b. An input/output port 9a on one side of each channel waveguide 9 is used as the input port 5, and the input/output ports 9a on the one side and input/output ports 9b on another side are respectively aligned in a straight line in a widthwise direction (X-axis direction).

An enlarged-waveguide portion 11, which is formed by enlarging the core 8a toward the input/output port 9b as viewed from the top by using a tapered waveguide or a slab waveguide, is formed on each channel waveguide 9 of the waveguide array 8. In addition, a bent portion 12 formed by bending the core 8a as viewed from the top to eliminate cladding mode is formed on each channel waveguide 9 on the input/output port 9a side (the input port 5 side) of the enlarged-waveguide portion 11. In addition, on the input/output port 9a side (the input port 5 side) of the bent portion 12, an input portion 13 for optically coupling the bent portion 12 to the input port 5 is formed.

Each channel waveguide 9 is formed so as to be aligned in a widthwise direction (X-axis direction). An input optical fiber array 14 formed by arranging plural optical fibers (optical fiber ports) 14a in an array manner is connected to the input ports 5 of the waveguide array 8, i.e., to the input/output port 9a of each channel waveguide 9. The bent portion 12 is to suppress crosstalk by eliminating cladding mode which occurs at the time of coupling the optical fiber array 14 to the input port 5.

The grating 10 on which ruled lines (concave or convex lines) are formed in a widthwise direction (X-axis direction) is used to demultiplex light in a vertical direction (Y-axis direction). The direction of the ruled line of the grating 10 coincides with the array direction of the channel waveguides 9. The grating 10 to be used desirably has large diffraction efficiency and a large difference in a reflection angle of each wavelength (large angular dispersion) and it is desirable to use a blazed grating or a grism. In this regard, the blazed grating is formed by blazing a normal holographic grating so that sawtooth-shaped protrusions are formed on a surface thereof, and the grism is a grating of which optical path is adjusted by covering a grating surface with a high refractive index prism. It is possible to further improve diffraction efficiency by arranging the blazed grating so as to be inclined with respect to the optical path. In addition, it is possible to increase angular dispersion by using a blazed grating having a smaller ruled line pitch or a grating having a larger diffraction order (a reflective echelle grating). In the present embodiment, a transmissive blazed grating used as the grating 10 is arranged so as to be inclined with respect to an X-Y axis plane. Note that, although the optical path after passing through the grating 10 may curve depending on an arrangement angle of the grating 10 or a design center wavelength, light beam with a center wavelength which travels along the Z-axis without curving before and after passing through the grating 10 is shown in the drawing here in order to simplify the explanation. In addition, the grating 10 is depicted as a thin ideal demultiplexing element in the subsequent drawings and the direction and arrangement angle of the blaze are not exact.

The lens system 7 is composed of a first lens 15 and a second lens 16 which act only in a vertical direction (Y-axis direction) and a third lend which acts only in a widthwise direction (X-axis direction).

The first lens 15 is a semi-cylindrical lens acting only in a vertical direction (Y-axis direction), is arranged between the waveguide array 8 and the grating 10 and is configured to collimate light emitted from the input/output port 9b of the waveguide array 8 and to output the collimated light to the grating 10. A distance between the input/output port 9b of the waveguide array 8 and the first lens 15 is equal to a focal length Fy of the first lens 15.

The second lens 16 is a semi-cylindrical lens acting only in a vertical direction (Y-axis direction) in the same manner as the first lens 15, is arranged between the grating 10 and the wavelength switching optical system 3 (a light deflector array 20) and is configured to focus the light of each wavelength demultiplexed by the grating 10 and to output the focused light to the wavelength switching optical system 3 (the light deflector array 20). A distance between the grating 10 and the second lens 16 and that between the second lens 16 and the light deflector array 20 are equal to a focal length fy of the second lens 16.

The first lens 15 and the second lens 16 are shown as a single lens (a semi-cylindrical lens) here in order to simplify the explanation but may be a compound lens to reduced influence of aberration, etc. The same applies to the third lens, a switching lens 22, a fourth lens 24 and a fifth lens 25 which are described below.

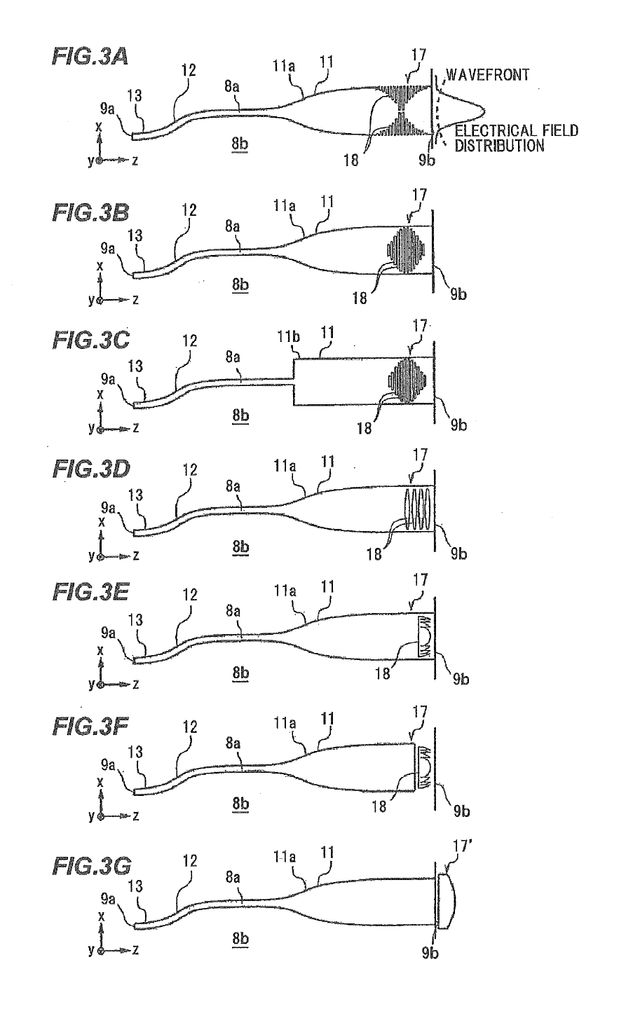

The third lens is a lens acting only in a widthwise direction and is separately provided in each input/output port 9b of the waveguide array 8. Here, a lens of which focal length is represented by 1/(n1/L1+1/L2) is used as the third lens, where the effective propagation length of the enlarged-waveguide portion 11 is L1, the effective refractive index of the enlarged-waveguide portion 11 is n1 and a distance between the third lens and the light deflector array 20 is L2. Since L2 is generally much longer than L1, the focal length of the third lens is approximately L1/n1. By such a configuration, the light passing through the third lens is focused on the light deflector array 20. The third lens may be a bulk cylindrical lens array 17′ shown in FIG. 3G arranged in a free space near the input/output port 9b of the waveguide array 8 or may be a waveguide lens 17 shown in FIGS. 3A to 3F provided in the waveguide near the input/output port 9b of the waveguide array 8. In the present embodiment, the waveguide lens 17 is used as the third lens.

The waveguide lens 17 is formed in the core 8a enlarged by the enlarged-waveguide portion 11 near the input/output port 9b of each channel waveguide 9. The enlarged-waveguide portion 11 may be formed by a tapered waveguide 11a as shown in FIG. 3A or a slab waveguide 11b as shown in FIG. 3C. When the tapered waveguide 11a is used as the enlarged-waveguide portion 11, an effective propagation distance L1 for sufficiently expanding the beam is long since a beam divergence angle is suppressed due to the effect of a tapered sidewall. On the other hand, the beam divergence angle is large when the slab waveguide 11b is used as the enlarged-waveguide portion 11, and the effective propagation distance L1 is shorter than the case of using the tapered waveguide 11a. Note that, the effective propagation distance L1 is equal to a curvature radius of a wavefront just before being incident on the waveguide lens 17 and, in case of using the slab waveguide 11b as the enlarged-waveguide portion 11, L1 roughly coincides with the length of the slab waveguide 11b.

As shown in FIG. 3A, the waveguide lens 17 may be formed in the core 8a of each channel waveguide 9 by filling a cladding material or a resin (optical plastics) having a lower refractive index than the core 8a into plural trenches 18 formed by trenching in a vertical direction (Y-axis direction). The plural trenches 18 are formed so that the total width of trenches forms a lens shape which is concave with respect to a light propagation direction as viewed from the top. The cladding 8b is used as a medium for filling the plural trenches 18 here so that the waveguide lens 17 is realized by the simplest structure.

A phase velocity Vp of light is approximately given by the following formula (1):

Vp=c/n (1)

where light speed in vacuum is c and a refractive index is n. Since the refractive index of the core 8a is larger than that of the cladding 8b, the phase velocity of light is smaller in the core 8a than in the cladding 8b. Therefore, the phase velocity of light is larger in the outer side (a peripheral edge) of the core 8a in which the number of the trenches 18 and the proportion of the cladding 8b are large, and is smaller as closer to the center of the core 8a. Accordingly, the light passing through the waveguide lens 17 has a concave wavefront distribution as viewed from the top (electrical field distribution is convex as viewed from the top). Since the light travels in a direction perpendicular to this level surface, i.e., to the wavefront, the light emitted from the waveguide array 8 propagates while being focused.

The reason why the waveguide lens 17 is formed of the divided trenches 18 as shown in FIG. 3A is that a confinement effect in a thickness direction of the core 8a (Y-axis direction) is reduced without dividing the trenches 18, resulting in occurrence of large optical loss. It is possible to provide a lens function with efficiency of not less than 90% by appropriately determining the width and division number of the trench 18.

The cladding 8b is used as a medium for filling the trenches 18 in the present embodiment. However, in this case, a large number (division number) of trenches 18 is required in order to function as a lens since the difference in a refractive index between the core 8a and the cladding 8b is small, which results in large optical loss due to influence of the trenches 18. In this regard, however, it is possible to reduce the number of trenches 18 and thus to further reduce optical loss by filling the trenches 18 with a material having a lower refractive index. In other words, as a medium for filling the trenches 18, it is desirable to use a resin having a lower refractive index than the cladding 8b.

Although the case where the trenches 18 formed in the core 8a are filled with a cladding or a resin having a lower refractive index than the core 8a to increase the phase velocity of light at the peripheral edge has been described in the present embodiment, it is obvious that it is possible to configure the waveguide lens 17 in an opposite manner such that the trenches 18 formed at the middle portion of the core 8a are filled with a resin having a higher refractive index than the core 8a to decrease the phase velocity of light at the middle portion.

In this case, as shown in FIG. 3B, plural trenches 18 are formed in the core 8a of each channel waveguide 9 by trenching in a vertical direction and are then filled with a resin having a higher refractive index than the core 8a so that the total width of trenches forms a lens shape which is convex with respect to a light propagation direction as viewed from the top.

The shape of the plural trenches 18 constituting the waveguide lens 17 is depicted as a bar-like shape in FIGS. 3A and 3B, but may be a concave or convex lens shape with a curved surface as shown in FIG. 3D (the convex shape is shown in FIG. 3D). Since the total width of trenches forms a lens shape which is concave or convex with respect to a light propagation direction as viewed from the top also in this case, the same light focusing function as the waveguide lens 17 formed of bar-shaped trenches is obtained.

Although an example of the waveguide lens 17 in which the total width of trenches forms a lens shape which is concave or convex with respect to a light propagation direction has been described thus far, the shape of the trench 18 may be a concave or convex Fresnel lens shape as shown in FIG. 3E (a convex shape is shown in FIG. 3E). A Fresnel lens-shaped trench 18 should be designed in a shape formed by dividing a concave or convex lens in a widthwise direction (X-axis direction) so that a phase difference between right and left of the division boundary is approximately integral multiple of 2π in an operating wavelength range. Due to such a phase design, the wavefront after passing through the trench is a smooth concave shape and acts to focus light. In addition, since the trench width as viewed in a light propagation direction can be thinned by forming the waveguide lens 17 into the Fresnel lens shape, loss due to light scattering in a Y-axis direction can be reduced.

As shown in FIG. 3F, the waveguide lens 17 formed of a Fresnel lens type trench 18 may be present in the cladding 8b near the output port of the core 8a, not in the core 8a. This is because influence of vertical scattering loss can be ignored since the trench width of the Fresnel lens type waveguide lens 17 is thin and the light confinement effect by the core 8a is thus not required.

The plural trenches 18 formed in a multistage manner in a light propagation direction (Z-axis direction) as shown in FIGS.3A and 3D may be unequally spaced. This is to suppress occurrence of Bragg diffraction resulting from a periodic-waveguide structure especially when the number of stages of the trenches 18 is large.

Next, the operation of the input demultiplexing optical system 2 will be described in reference to FIGS. 2A and 2B. Hereinafter, a Y-Z axis plane on which an optical signal is demultiplexed is referred to as a dispersion plane, and an X-Z axis plane on which the optical fiber array 14 is arranged is referred to as a switching plane. In the wavelength cross connect device 1, the dispersion plane and the switching plane are significantly different in behavior of light and will be separately described in reference to the side view in FIG. 2A (corresponding to the dispersion plane) and the top view in FIG. 2B (corresponding to the switching plane).

As shown in FIG. 2A, in the dispersion plane, light composed of signals of various wavelengths incident on the optical fiber array 14 passes through the waveguide array 8, is emitted from the input/output port 9b, is spread in a vertical direction (Y-axis direction) by diffraction, is incident on and collimated by the first lens 15 and is then incident on the grating 10. Since the grating 10 is arranged so that the concave-convex ruled lines thereof are parallel to the X-axis, the light incident on the grating 10 is demultiplexed into each wavelength in a vertical direction (Y-axis direction), i.e., within the dispersion plane, is incident on and focused by the second lens 16 and is then output to the wavelength switching optical system 3 (the light deflector array 20).

Here, it is possible to realize Fourier optics configuration by adjusting the distance between the second lens 16 and the light deflector array 20 to be equal to the focal length fy of the second lens 16, and the lights of respective wavelengths passing through the grating 10 pass through the second lens 16 and are then focused at different positions in the Y-axis direction while travelling in parallel, and are form images on the light deflector array 20.

On the other hand, in the switching plane, the light incident from the input optical fiber array 14 is spread in a widthwise direction (X-axis direction) by the enlarged-waveguide portion 11 of the channel waveguide 9, is focused by the waveguide lens 17, then propagates while being focused and is output to the wavelength switching optical system 3 (the light deflector array 20) as shown in FIG. 2B. It should be noted that only the light of wavelength indicated by hatching in FIG. 2A is extracted and shown in FIG. 2B. In the switching plane, the first lens 15, the second lens 16 and the grating 10 do not exert practically any influence.

Since the distance between the waveguide lens 17 and the light deflector array 20 is set so that the light passing through the waveguide lens 17 is focused on the light deflector array 20, light beam forming an image on the light deflector array 20 is a beam waist of which spot diameter is the smallest. In addition, on one hand, the spot diameter of the waveguide lens 17 in a widthwise direction (X-axis direction) becomes large to some extent since a distance from the waveguide lens 17 to the focal point thereof is long, and on the other hand, the spot diameter in a vertical direction (Y-axis direction) of the second lens 16 having the focal length fy is small since a distance from the second lens 16 to the focal point thereof is shorter than that of the waveguide lens 17 and also the spot diameter of the light incident on the second lens 16 is large, which results in that the spot shape of the light beam forming an image on the light deflector array 20 becomes a horizontal oval shape.

Output Multiplexing Optical System

Next, the output multiplexing optical system 4 will be described.

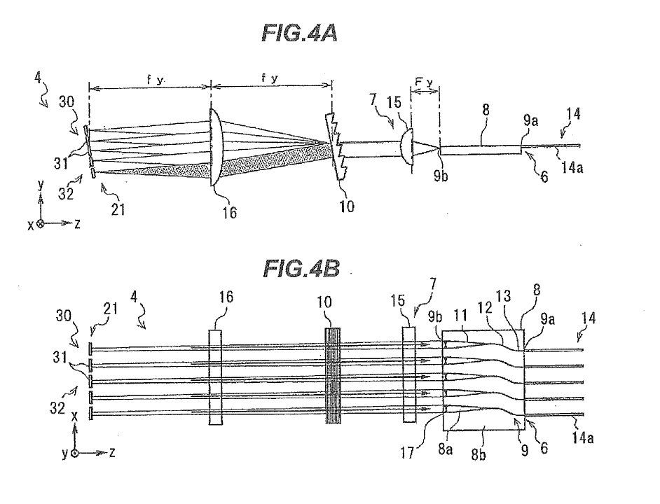

As shown in FIGS. 1, 4A and 4B, the output multiplexing optical system 4 has substantially the same structure as the input demultiplexing optical system 2 but input and output thereof are reversed.

That is, the output multiplexing optical system 4 is formed by sequentially arranging the second lens 16, the grating 10, the first lens 15 and the waveguide array 8 from the wavelength switching optical system 3 side.

In the output multiplexing optical system 4, the grating 10 serves to re-multiplex the lights of respective wavelengths input from the wavelength switching optical system 3 (a light deflector array 21) and to make the multiplexed lights incident on the input/output ports 9b of the waveguide array 8. Since lights are output from the wavelength switching optical system 3 (the light deflector array 21) so that the order of the wavelengths is vertically revered in the dispersion plane, the grating 10 in the output multiplexing optical system 4 is arranged to be upside down as compared to the input demultiplexing optical system 2. The detail thereof will be described later.

In addition, in the output multiplexing optical system 4, the lens system 7 serves to convert the horizontal oval-shaped focal point of the light of each wavelength input from the wavelength switching optical system 3 (the light deflector array 21) back into a focal point having the same shape as an image of the output port. The second lens 16 serves to focus the light of each wavelength input from the wavelength switching optical system 3 (the light deflector array 21) and to output the focused light to the grating 10, and the first lens 15 serves to focus the light input from the grating 10 and to make the focused light incident on the input/output port 9b of the waveguide array 8.

The input/output port 9a of the waveguide array 8 of the output multiplexing optical system 4 is used as the output port 6 and is connected to an output optical fiber array 14.

Wavelength Switching Optical System

Next, the wavelength switching optical system 3 will be described.

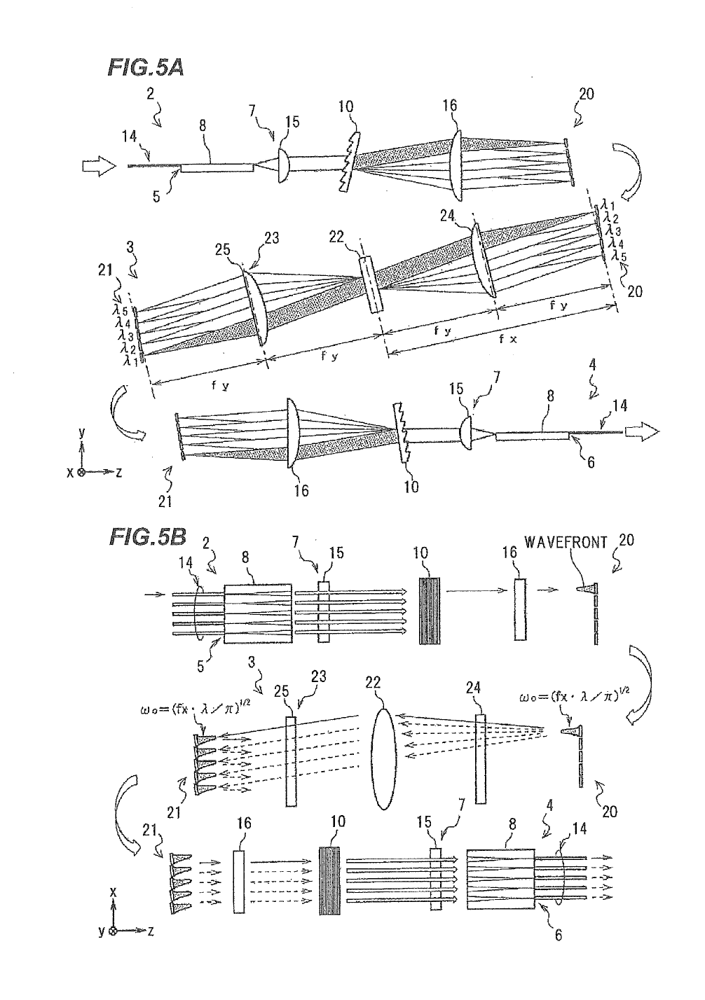

As shown in FIGS. 1, 5A and 5B, the wavelength switching optical system 3 is provided with two light deflector arrays 20 and 21, the switching lens 22 having a focal length equal to the Rayleigh length and acting only in a widthwise direction (X-axis direction) and plural Fourier optical lenses 23 which act only in a vertical direction (Y-axis direction).

The two light deflector arrays 20 and 21 are oppositely arranged at respective focal positions of the lens systems 7 of the input demultiplexing optical system 2 and the output multiplexing optical system 4 (the focal position of the second lens 16 as well as the focal position of the waveguide lens 17). The light deflector arrays 20 and 21 have two-dimensional light deflection elements vertically and horizontally arranged so as to correspond to the light of each wavelength of each port and are configured to output incoming light of each wavelength after adjusting a horizontal reflection angle of the light.

In the present embodiment, a MEMS mirror array 30 composed of two-dimensionally arranged MEMS mirrors 31 which are light deflection elements is used as the light deflector arrays 20 and 21.

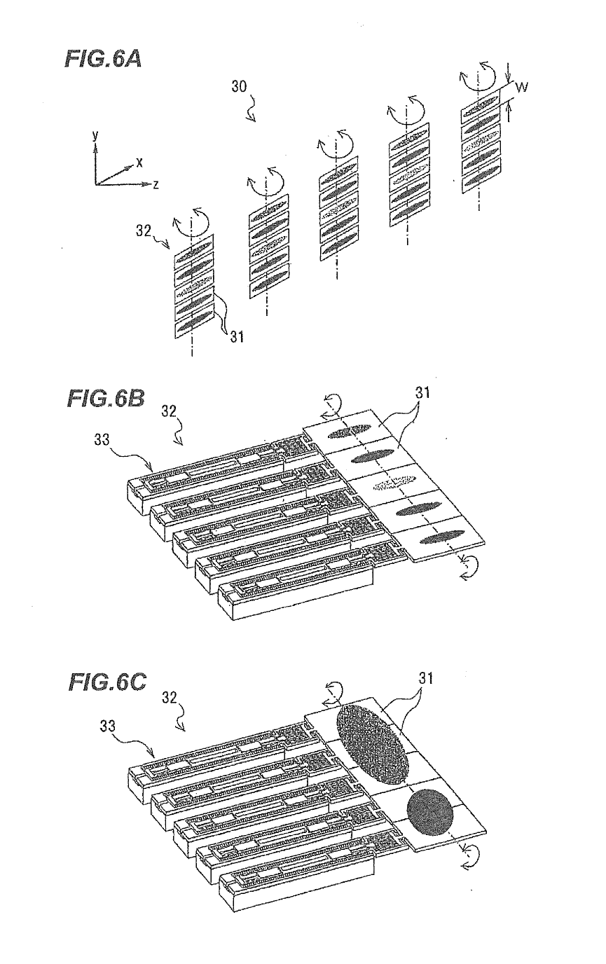

As shown in FIGS. 1 and 5A to 6B, plural strip-shaped one-dimensional MEMS mirror groups 32 each composed of plural MEMS mirrors 31 one-dimensionally arranged in a vertical direction are used as light deflectors and the MEMS mirror array 30 is formed by arranging the plural MEMS mirror groups 32 in an array manner in a widthwise direction (X-axis direction) so as to correspond to each port. The array direction of the one-dimensional MEMS mirror groups 32, the direction of the ruled line of the grating 10 and the array direction of the channel waveguides 9 coincide with each other. For the purpose of simplification, FIGS. 6A to 6B show as if each MEMS mirror 31 is arranged on the X-Y axis plane. However, the MEMS mirror array 30 is actually arranged on that the MEMS mirrors 31 thereof are inclined with respect to the X-Y axis plane, as shown in FIGS. 1, 5A and 5B.

Each one-dimensional MEMS mirror group 32 has substantially the same structure in which basic structures each composed of the MEMS mirror 31 and an actuator 33 for driving the MEMS mirror 31 are arranged in a vertical direction (Y-axis direction). Each MEMS mirror 31 can be rotated by changing voltage applied to the actuator 33 and it is thereby possible to freely deflect light beam.

Since a signal frequency interval (interval at the reciprocal value of the wavelength) in conventionally and typically used wavelength multiplexing communications is fixed at 100 GHz or 50 GHz, the MEMS mirror 31 is formed so that a pitch (interval in the array direction) W thereof is a width corresponding to such a signal frequency interval in case of applying to general wavelength multiplexing communications.

However, in recent years, a technique to transmit a large amount of information even at the same spectrum by respectively controlling optical phase and amplitude has been being developed and, in such a case, a spectrum width momentarily varies in accordance with data to be transmitted and it is thus not possible to handle by the MEMS mirror array 30 in which the pitch W of the MEMS mirrors 31 is a constant frequency interval of 50 GHz or 100 GHz as described above.

In order to address this problem, in the present embodiment, each one-dimensional MEMS mirror group 32 is configured such that the grouped plural MEMS mirrors 31 can be controlled to be inclined at the same angle so that the frequency interval to be switched can be adaptively changed. Desirably, the pitch W of each MEMS mirror 31 is set to correspond to a frequency interval of not more than 12.5 GHz and a gap between the adjacent MEMS mirrors 31 is set to not more than a spot-size of incoming light.

When the pitch W of each MEMS mirror 31 is set to correspond to a frequency interval of, e.g., 12.5 GHz, a spread signal spectrum of 37.5 GHz can be covered by grouping three MEMS mirrors 31 and a spread signal spectrum of 25 GHz can be covered by grouping two MEMS mirrors 31, as shown in FIG. 6C. Likewise, the frequency interval to be covered is 50 GHz when simultaneously operating four MEMS mirrors 31. and is 100 GHz when simultaneously operating eight MEMS mirrors 31, which means that it is possible to freely change the frequency interval at every 12.5 GHz.

As such, the grouped plural MEMS mirrors 31 configured to reflect light at the same angle in a parallel manner can be used as one mirror. Very accurate parallelism is required in this case but the parallelism can be controlled by voltage applied to the actuator 33 and is finely adjustable, hence, no problem arises. In addition, since each gap between MEMS mirrors 31 is not more than the spot-size of incoming light, influence of the gap is ignorable.

A lens system of the wavelength switching optical system 3 will be described in reference to FIGS.1, 5A and 5B again.

The wavelength switching optical system 3 couples the input demultiplexing optical system 2 to the output multiplexing optical system 4 by using a lens system. The lens system is composed of the switching lens 22 acting only in a widthwise direction (X-axis direction) and the plural Fourier optical lenses 23 acting only in a vertical direction (Y-axis direction) and has a function of independently focusing lights in vertical and widthwise directions.

The switching lens 22 is a columnar lens (a convex lens as viewed from the top) having a focal length fx equal to the Rayleigh length and acting only in a widthwise direction, and is arranged between the light deflector arrays 20 and 21 so that distances from the two light deflector arrays 20 and 21 are both equal to the focal length (i.e., the Rayleigh length) fx. The switching lens 22 converts a horizontal angle of the light of each wavelength adjusted by the light deflector array 20 into a horizontal position (offset) on the light deflector array 21, thereby performing switching.

The focal length (i.e., the Rayleigh length) fx of the switching lens 22 is represented by the following formula (2):

fx=πω₀²/λ (2)

where ω₉ is a spot radius in the X-axis direction on the light deflector, fx is the focal length (the Rayleigh length) and λ is a wavelength of light.

It is generally known that light beam incident from the same distance as a focal length of a lens is Fourier-transformed after passing through the lens and propagating in the focal length such that a positional shift is converted into an angular shift and vice versa and an output spot diameter is converted into a size inversely proportional to an input spot diameter. However, in the lens of which focal length fx satisfies the above formula (2), diameters of input and output beam spots located at a distance fx before and after the lens are the same ω₀.

The Fourier optical lens 23 acts only in a vertical direction and is provided in multiple stages so as to convert a vertical angle into a vertical position and subsequently the vertical position back into the vertical angle.

In the present embodiment, two semi-cylindrical lenses, the fourth lens 24 and the fifth lens 25, are used as the Fourier optical lenses 23 such that the fourth lens 24 is arranged between the light deflector array 20 and the switching lens 22 and the fifth lens 25 is arranged between the witching lens 22 and the light deflector array 21. The fourth lens 24 serves to convert the vertical angle into the vertical position and the fifth lens 25 serves to convert the vertical position back into the vertical angle.

Both of the fourth lens 24 and the fifth lens 25 are a lens with a focal length fy which is equal to each of a distance between the fourth lens 24 and the light deflector array 20, that between the fourth lens 24 and the switching lens 22, that between the witching lens 22 and the fifth lens 25 and that between the fifth lens 25 and the light deflector array 21. In this configuration example, in order to form an image of a light spot on the two facing light deflector arrays 20 and 21 in both of the dispersion plane and the switching plane, it is necessary to satisfy the condition of the following formula (3):

2·fy=fx (3)

It should be noted that the condition of (3) may not be satisfied when it is designed such that a compound lens formed by combining plural lenses is used as a lens group (the fourth lens 24, the fifth lens 25 and the witching lens 22) to relate the light deflector array 20 to the light deflector array 21 and equivalent focal lengths in X- and Y-axis directions are respectively fx and fy.

Although the lens having the same focal length as the second lens 16 is used as the fourth lens 24 and the fifth lens 25 here, a lens having a different focal length from the second lens 16 may be used. In this regard, however, the focal length of the fourth lens 24 needs to be the same as that of the fifth lens 25.

The wavelength switching optical system 3 is arranged so as to be inclined with respect to the input demultiplexing optical system 2 and the output multiplexing optical system 4 as viewed from a side (i.e., inclined with respect to the X-Z axis plane). Accordingly, the light deflector array 20 is arranged so that the light of each wavelength input from the Z-axis direction (from the input demultiplexing optical system 2) is reflected obliquely downward, and the light deflector array 21 is arranged so that the light input from obliquely above is reflected in the Z-axis direction (toward the output multiplexing optical system 4). The both light deflector arrays 20 and 21 are arranged so as to be 180-degree rotationally-symmetric about the X-axis and to have tilt angles which are reverse to each other. An inclination angle of the wavelength switching optical system 3 with respect to the input demultiplexing optical system 2 and the output multiplexing optical system 4 only needs to be appropriately determined to the extent that interference does not occur between the wavelength switching optical system 3 and the input demultiplexing optical system 2 or the output multiplexing optical system 4.

Next, the operation of the wavelength switching optical system 3 will be described in reference to FIGS. 5A and 5B. Note that, the input demultiplexing optical system 2 and the output multiplexing optical system 4 are also shown in FIGS. 5A and 5B.

As shown in FIG. 5A, in the dispersion plane, the lights demultiplexed by the grating 10 of the input demultiplexing optical system 2 are input to the light deflector array 20. At this time, in each one-dimensional MEMS mirror group 32, a group of optical signals having the same wavelength X1 forms an image on a first MEMS mirror 31 and a group of optical signals having the same wavelength λ2 forms an image on a second MEMS mirror 31, hence, lights having the same wavelength are aligned in a widthwise direction.

The light of each wavelength input from the input demultiplexing optical system 2 is reflected by the light deflector array 20 and is Fourier-transformed by the fourth lens 24. Subsequently, the light is Fourier-transformed again by the fifth lens 25, is reflected by the light deflector array 21 and is output to the output multiplexing optical system 4.

In the dispersion plane, although the order of the focal positions corresponding to the wavelengths are vertically reversed as compared to those of the input lights due to effect of the fourth lens 24 and the fifth lens 25, the same spot diameter as that on the input-side light deflector array 20 can be reproduced on the output-side light deflector array 21. In the dispersion plane, the switching lens 22 basically does not exert any influence. In addition, the both light deflector arrays 20 and 21 adjust only a reflection direction in a widthwise direction (X-axis direction) (only operate one-dimensionally) and thus basically does not exert any influence in the dispersion plane.

On the other hand, as shown in FIG. 5B, switching of the lights of the same wavelength is performed in the switching plane. It should be noted that only the light of the wavelength indicated by hatching in FIG. 5A is extracted and shown in FIG. 5B. In addition, only the light beam input from the uppermost port in the drawing of the input demultiplexing optical system 2 is extracted and shown in FIG. 5B. Note that, in the switching plane, the fourth lens 24 and the fifth lens 25 do not exert practically any influence.

The reflection angle of the light of each wavelength input from the input demultiplexing optical system 2 is appropriately adjusted in a widthwise direction (X-axis direction) by the light deflector array 20 so as to correspond to a desired switching destination port and the light is then reflected. The reflection angle is controlled by voltage applied to the actuator 33 of the corresponding MEMS mirror 31. The light of each wavelength reflected by the light deflector array 20 passes through the switching lens 22 and is output to the light deflector array 21. Since the angular shift is converted into the positional shift by the switching lens 22 at this time, the light of each wavelength after passing through the switching lens 22 is converted into a parallel beam group of which position is different depending on the reflection angle, and the horizontal angle of the light of each wavelength adjusted by the light deflector array 20 is converted into a horizontal position on the light deflector array 21.

In other words, changing the applied voltage to the light deflector array 20 allows switching of the light of each wavelength to be performed onto the light deflector array 21 as indicated by a dashed line in FIG. 5B while maintaining the same beam spot diameter (a spot radius in the X-axis direction) ω₀ on the input and output sides. The spot diameter ω₀ is represented by the following formula (4) as a modification of the above formula (2):

ω₀−(fx·λ/π)^{1/2} (4)

In addition, the light of each wavelength can be reflected in a horizontal direction (Z-axis direction) and then output to the output multiplexing optical system 4 by appropriately inclining the deflection angle of the output-side light deflector array 21. In the output multiplexing optical system 4, the light of each wavelength is multiplexed per port and the multiplexed light is output from the output port 6 to each optical fiber 14a of the optical fiber array 14.

As described above, in the wavelength switching optical system 3, the light input from the input port 5 can be switched for each wavelength and output from a given output port 6 by changing voltages applied to the both light deflector arrays 20 and 21,

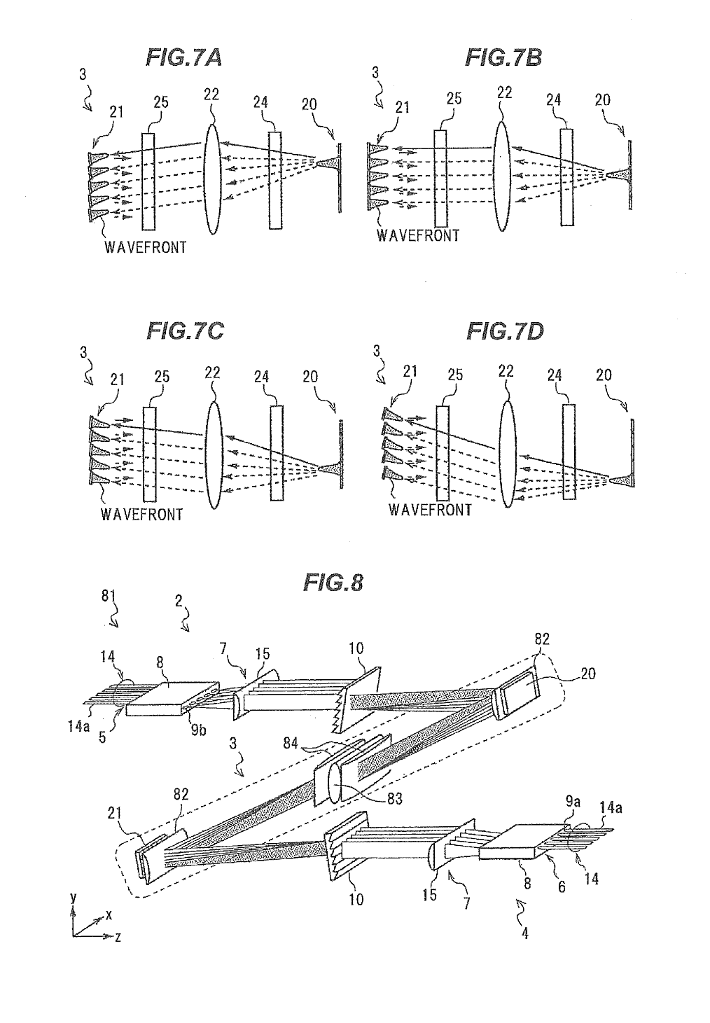

Although FIG. 5B only shows the switching operation of the light beam input from the uppermost port in the drawing, respective switching operations of the second to fifth ports in the drawing which are as shown in FIGS. 7A to 7D are the same switching operation as that of the uppermost port in the drawing.

In the wavelength switching optical system 3, the light of each port is independently switchable without exerting influence on each other and is independently switchable for each wavelength. Therefore, it is possible to independently switch an optical signal having a given wavelength, among optical signals input to a given input port 5, to a given output port 6 and it is thus possible to realize an M×N wavelength cross connect device 1 having an extremely high degree of freedom.

### Effects of the Present Embodiment

The effects of the present embodiment will be described.

In the wavelength cross connect device 1 of the present embodiment, the input demultiplexing optical system 2 and the output multiplexing optical system 4 are provided with the lens system 7 having a function of independently focusing lights in vertical and widthwise directions such that the spot shape on the light deflector arrays 20 and 21 is a horizontal oval shape.

Providing the lens system 7 having a function of independently focusing lights in vertical and widthwise directions allows ovality of light distribution on the light deflector arrays 20 and 21 to be controlled and it is thus possible to obtain a horizontal oval shape in which a spot diameter in a vertical direction (a demultiplexing direction) is small and a spot diameter in a widthwise direction (a switching direction) is slightly large.

The focal point in the demultiplexing direction (vertical direction) needs to be as small as possible in order to obtain good flat-top response but focal point in a direction of deflecting light beam at the time of switching (widthwise direction) needs to be large to some extent. The present embodiment satisfies these requirements by providing a horizontal oval-shaped focal point using the lens system 7 having a function of independently focusing lights in vertical and widthwise directions. As a result, it is possible to realize flat-top response and low crosstalk even by using the MEMS mirror 31 having a small area, and it is thus easy to provide multiple ports.

In addition, in the wavelength cross connect device 1, since the switching lens 22 having a focal length equal to the Rayleigh length and acting only in a widthwise direction is provided between the two oppositely arranged light deflector arrays 20 and 21 so that switching is performed by converting the angular shift into the positional shift at the switching lens 22, an image on the MEMS mirror 31 is a beam waist and a spot size is small. Therefore, the mirror area in the switching direction can be small and it is easy achieve integration and multiport.

Furthermore, in the wavelength cross connect device 1, the switching lens 22 acting only in a widthwise direction is used to allow light of each wavelength to be independently switched. Therefore, it is possible to realize the wavelength cross connect device 1 having an extremely high degree of freedom and the structure is simple and cheap since the number of spectrograph-demultiplexers to be connected to multiplex and demultiplex wavelengths does not need to be the same as the number of input/output ports unlike the conventional technique.

Still further, in the wavelength cross connect device 1, the waveguide lens 17 is used as the third lens. As the third lens, for example, a cylindrical lens array acting only in a widthwise direction may be used so as to correspond to the input/output port 9b of each channel waveguide 9 but such a lens array is difficult to manufacture and is expensive. The waveguide lens 17 is cheaper than such a lens array and can be easily manufactured.

In addition, in the present embodiment, the plural MEMS mirrors 31 are grouped and are controlled so as to be inclined at the same angle.

A conventional wavelength cross connect device does not have a problem when a wavelength in wavelength-multiplexing communications used for optical system is fixed since one MEMS mirror simply corresponds to one wavelength but it cannot be used when wavelength assignment changes over time. In recent optical communication, it becomes important to flexibly change wavelength by an optical signal modulation method, and in the present embodiment it is possible to accommodate change in the wavelength assignment over time by grouping the plural MEMS mirrors 31.

Since the optical system used in the present embodiment passes only twice through the grating 10 which is an element with relatively large loss, it is not necessary to repeatedly multiplex/demultiplex for several times by the grating unlike the conventional art and it is possible to realize the wavelength cross connect device 1 with low loss.

### Other Embodiments

Next, other embodiments of the invention will be described.

A wavelength cross connect device 81 shown in FIG. 8 basically has the same structure as the wavelength cross connect device 1 in FIG. 1 but is configured such that the Fourier optical lens 23 of the wavelength switching optical system 3 is composed of two semi-cylindrical lenses 82 and a columnar lens 83, the switching lens 22 has a divided structure composed of two semi-cylindrical lenses 84, and further, the second lens 16 is omitted.

The semi-cylindrical lenses 82 are arranged in the vicinity of the light deflector arrays 20 and 21 so as to act on both of light propagating between the gratings 10 and the light deflector arrays 20, 21 and light propagating between the two light deflector arrays 20 and 21. The columnar lens 83 is arranged in the middle between the two light deflector arrays 20 and 21, and the two semi-cylindrical lenses 84 to be the switching lens 22 are arranged so as to sandwich the columnar lens 83 from both sides. Meanwhile, the light focusing function served by the second lens 16 in the wavelength cross connect device 1 is realized by a configuration in which a distance between the input/output port 9b and the first lens 15 is a distance Fy+ΔF which is slightly larger than the focal length Fy of the first lens 15.

The number of the lenses used in the wavelength cross connect device 81 is the same as that in the wavelength cross connect device 1 of FIG. 1 but the position of each lens is different. Such a configuration provides the same effects as those of the wavelength cross connect device 1 and also allows further size reduction.

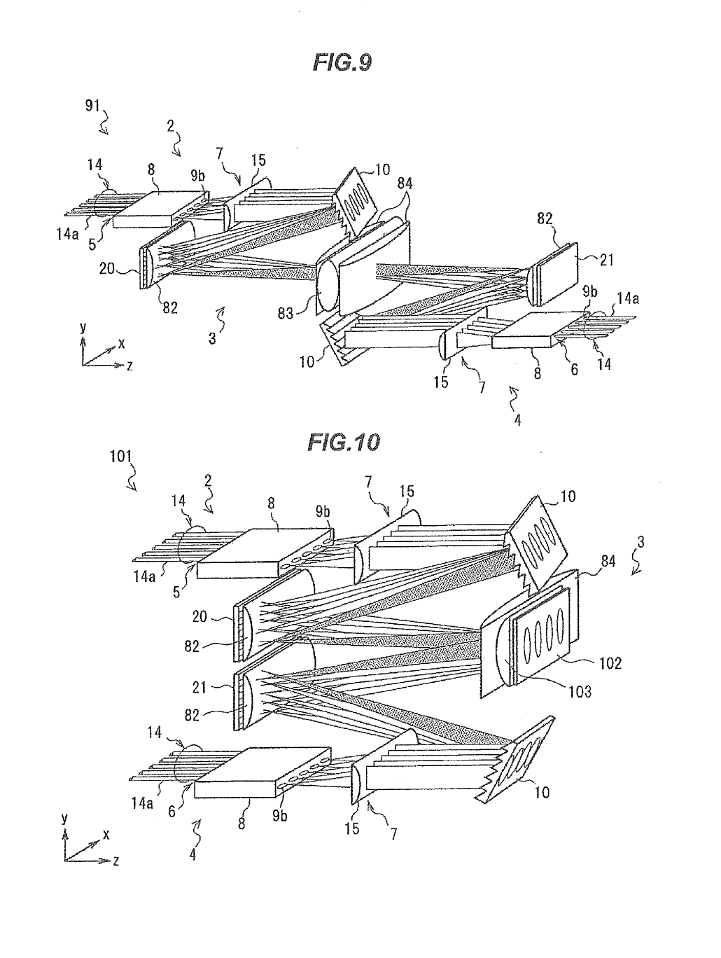

A wavelength cross connect device 91 of FIG. 9 is based on the wavelength cross connect device 81 of FIG. 8 and is configured such that a reflective blazed grating is used as the grating 10. The reflective grating 10 is capable of increasing angular dispersion more than a transmissive grating and is used when the transmissive grating has a difficulty due to a narrow wavelength interval of optical signals. In addition, the wavelength cross connect device 91 allows further size reduction to be realized.

A wavelength cross connect device 101 of FIG. 10 is based on the wavelength cross connect device 91 of FIG. 9 and is configured such that a mirror 102 is further arranged in the middle of the wavelength switching optical system 3 so that the wavelength switching optical system 3 turns back at the middle portion. In this case, it is configured such that the columnar lens 83 is replaced with a semi-cylindrical lens 103 and one semi-cylindrical lens 84 is used as the switching lens 22. The wavelength cross connect device 101 allows further size reduction to be realized such that the size thereof can be reduced to about ¼ or less of the wavelength cross connect device 1 of FIG. 1.

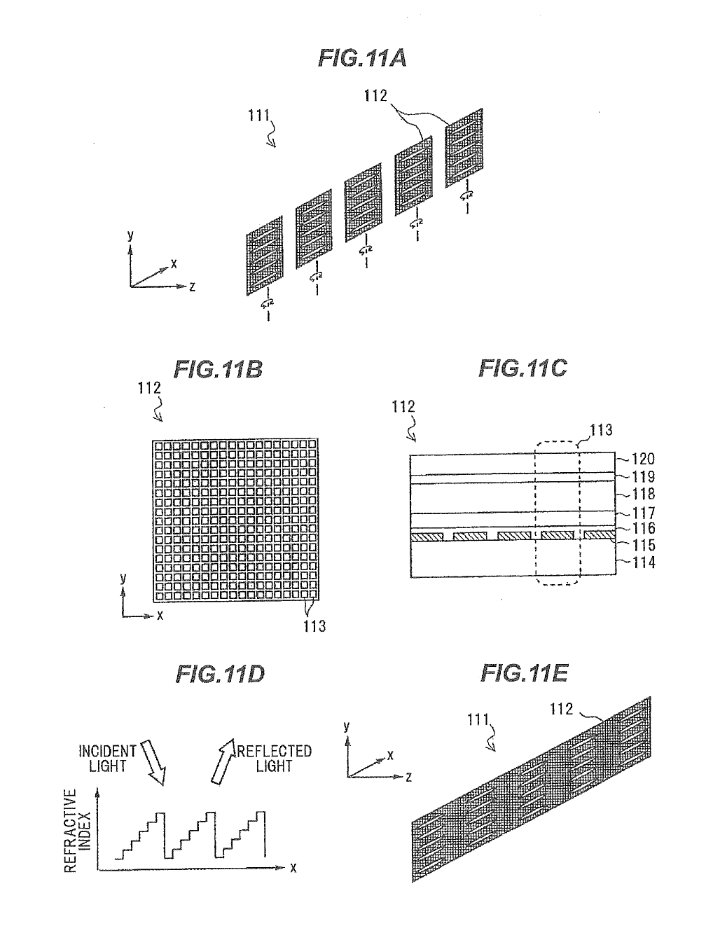

In addition, although the MEMS mirror array 30 is used as the light deflector arrays 20 and 21 in the present embodiment, it is not limited thereto and an LCOS (Liquid Crystal on Silicon) chip array 111 shown in FIG. 11A may be used as the light deflector arrays 20 and 21.

As shown in FIG. 11A, the LCOS chip array 111 is composed of plural LCOS chips 112 as light deflectors which are arranged in a widthwise direction (X-axis direction) in an array manner so as to correspond to each port. For one-to-one correspondence of the LCOS chip 112 to each port, the array direction of the channel waveguides 9 needs to coincide with the array direction of the LCOS chips 112.

Also in the case of using the LCOS chip array 111 as the light deflector arrays 20 and 21, an optical signal group having the same wavelength forms an image on the same vertical position (Y-axis direction) on each LCOS chip 112 and lights with the same wavelength are aligned in a widthwise direction (X-axis direction) in the same manner as the case of using the MEMS mirror array 30.

As shown in FIGS. 11B and 11C, the LCOS chip 112 is composed of plural pixels (cells) 113 arranged within a plane in a matrix manner. The LCOS chip 112 is formed by sequentially laminating an electrode 115, a reflective film (dielectric reflective film) 116, a ¼ wavelength layer (¼ wavelength film) 117, a liquid crystal layer 118, a transparent electrode 119 and a cover glass 120 on a silicon IC (silicone substrate) 114.

That is, the LCOS chip 112 used here is different from atypical LCOS chip and has the ¼ wavelength layer 117 formed between the liquid crystal layer 118 and the reflective film 116. The liquid crystal layer 118 of the LCOS chip 112 can change a refractive index of only a polarized component which vibrates in one axis direction.

However, by forming the ¼ wavelength layer 117, incident S-polarized light is reflected by the reflective film 116 and is subsequently converted into P-polarized light or the P-polarized light is converted into the S-polarized light after being reflected in the same manner. This allows the liquid crystal layer 118 to act on both polarized lights to change a refractive index and it is thus possible to realize polarization independence.

In the LCOS chip 112, it is possible to change a refractive index of the liquid crystal layer 118 of the pixel 113 by applying voltage to each pixel 113 which constitutes the LCOS chip 112. For example, voltage applied to each pixel 113 is adjusted so that the liquid crystal layer 118 has sawtooth-shaped refractive-index distribution with a periodic repetition of 0 to 2π as shown in FIG. 11D and inclination thereof is changed to allow light beam to be freely deflected. Furthermore, in the LCOS chip 112, since the sawtooth-shaped refractive-index distribution as shown in FIG. 11D can be freely determined in a give region on the LCOS chip 112, it is possible to easily correspond to spread of various spectra which depend on a modulated signal of e.g., 25 GHz, 50 GHz or 100 GHz, etc.

Alternatively, the light deflector arrays 20 and 21 may be the LCOS chip 112 in one-piece as shown in FIG. 11E which is configured such that an oval-shaped focal point group corresponding to all operating wavelengths output from each port falls within an effective diameter of the LCOS chip 112. While the LCOS chip 112 having a large area is required in this case, it is advantageous in reduction in the number of components, easy assembly and simple control.

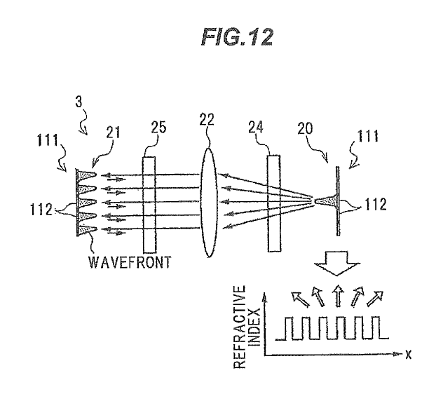

In addition, multicast (branch output) which cannot be realized by the MEMS mirror array 30 can be realized when the LCOS chip is used as the light deflector arrays 20 and 21. For example, two orders of diffracted light is mainly exited when rectangular binary refractive-index distribution as shown in FIG. 12 (refractive-index distribution in which high- and low-level refractive-indexes are alternately repeated at a predetermined cycle) is provided to the LCOS chip 112, which allows the input light beam to be split and output in two directions. By providing refractive-index distribution in another form without limiting to the binary form, it is possible to adjust an excitation balance of each order of diffracted light and this allows multicast of one optical signal to many output ports 6.

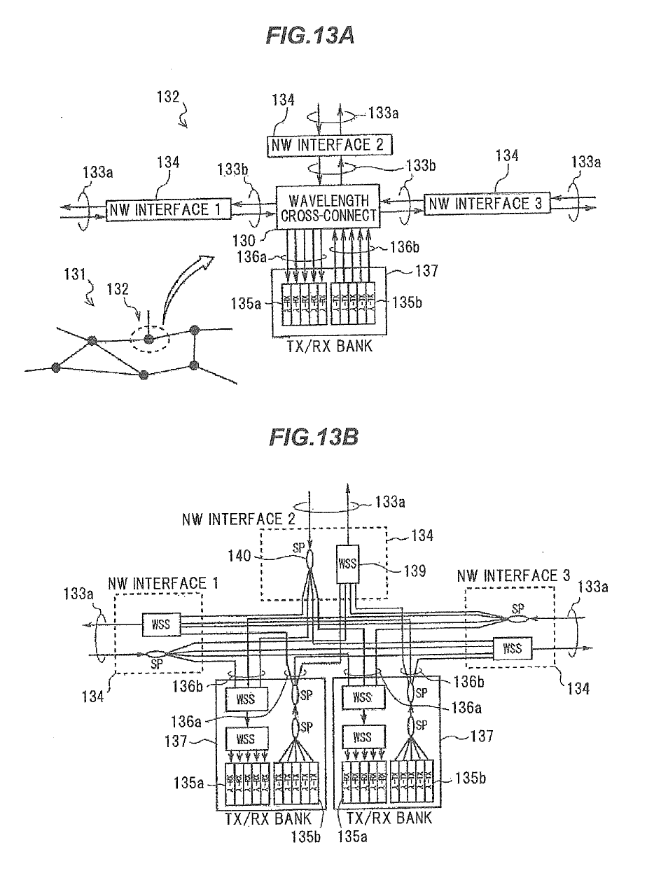

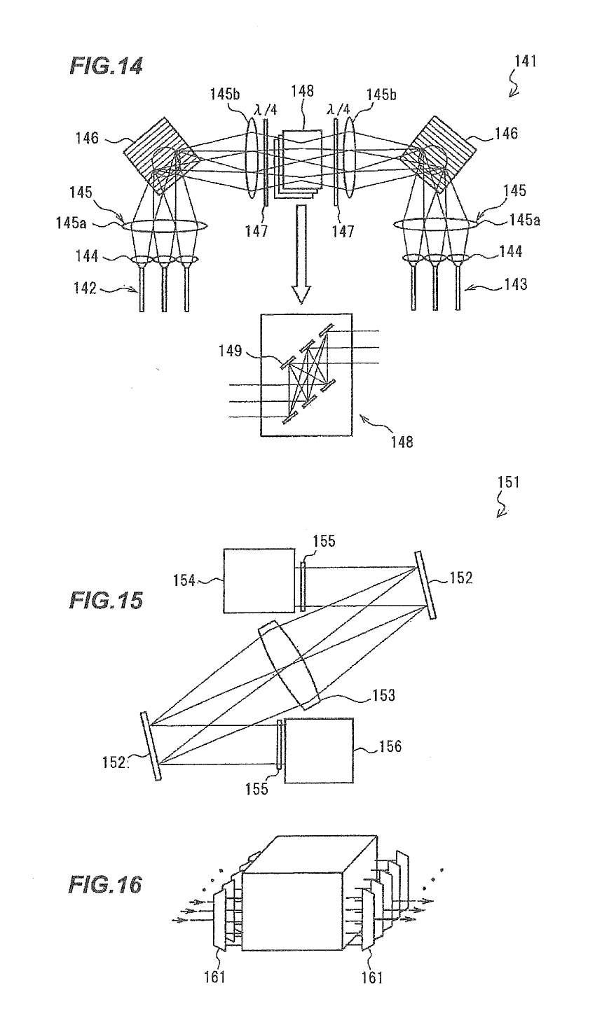

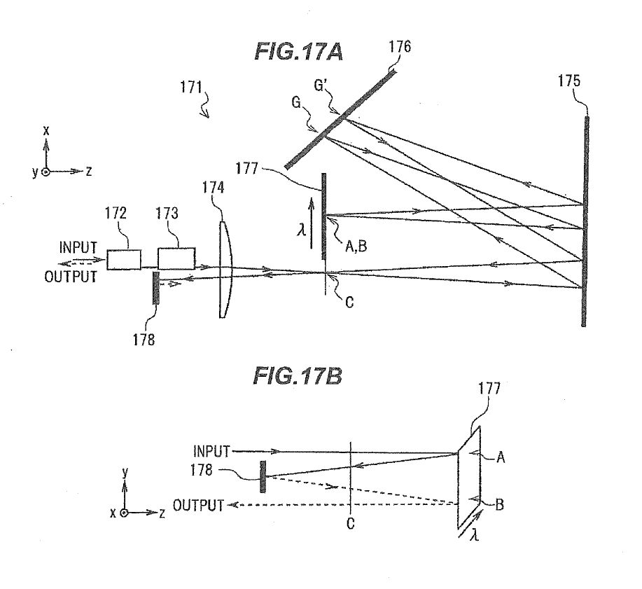

As shown in FIG. 13A, the wavelength cross connect device of the invention is used for, e.g., a node device 132 of a next generation optical communication system 131. FIG. 13A shows the node device 132 in which pair optical fibers 133a are respectively laid toward three nodes.

The node device 132 is provided with three network interfaces (NW interfaces) 134 corresponding to the three nodes, and the pair optical fibers 133a are connected to the respective corresponding network interfaces 134. In addition, the node device 132 is provided with a TX/RX bank 137 which includes plural wavelength-tunable optical receivers (λ-RX) 135a and plural wavelength-tunable optical transmitters (λ-TX) 135b.

This node device 132 is configured such that the three network interfaces 134 are connected to a wavelength cross connect device 130 of the invention via respective pair optical fibers 133b, and Drop ports 136a and Add ports 136b of the TX/RX bank 137 are connected to the wavelength cross connect device 130 of the invention. Even in the case of further including a backup TX/RX bank, it is only necessary to connect Drop and Add ports of the backup TX/RX bank to the wavelength cross connect device 130.

Meanwhile, a system configuration in a case of using a conventionally-used 1×N wavelength-selective switch (WSS) is shown in FIG. 13B. In this case, it is necessary to provide many 1·N wavelength-selective switches 139 and optical splitters (SP) 140 as shown in FIG. 13B, which makes the system configuration very complicated.

As understood by comparing FIG. 13A with FIG. 13B, use of the wavelength cross connect device 130 of the invention allows the system configuration to be very simple. As a result, it is possible to significantly downsize the node device 132 and to significantly reduce the cost. Furthermore, introduction into a wide range of network including metro-core, metro-edge and access system network is expected due to the cost reduction, which leads to innovative development of optical network.

The invention is not intended to be limited to the embodiments and it is obvious that the various kinds of changes can be added without departing from the gist of the invention.

What is claimed is:

1. A wavelength cross connect device, comprising:
an input demultiplexing optical system that demultiplexes light input from a plurality of input ports into respective wavelengths and outputs the demultiplexed lights;
a wavelength switching optical system for switching and outputting the lights of respective wavelengths input from the input demultiplexing optical system to respective desired ports; and
an output multiplexing optical system that multiplexes the lights of respective wavelengths input from the wavelength switching optical system per port and outputs the multiplexed lights through corresponding output ports,
wherein the input demultiplexing optical system and the output multiplexing optical system are configured such that optical paths of the lights from the respective ports are aligned in parallel to each other in a widthwise direction and light from each port is demultiplexed or multiplexed in a vertical direction, and comprise a lens system that has a function of focusing lights independently in vertical and widthwise directions so as to focus the light of each wavelength output to the wavelength switching optical system into a horizontal oval shape or so as to convert the horizontal oval-shaped focal point of the light of each wavelength input from the wavelength switching optical system back into a focal point having the same shape as an image of the output port, and
wherein the wavelength switching optical system comprises:
two light deflector arrays being oppositely arranged at respective focal positions of the lens systems of the input demultiplexing optical system and the output multiplexing optical system and comprising two-dimensional light deflection elements vertically and horizontally arranged so as to correspond to the light of each wavelength of each port to output incoming light of each wavelength after adjusting a horizontal reflection angle of the light; and
a switching lens comprising a lens that has a focal length equal to the Rayleigh length and acts only in a widthwise direction, being arranged between the two light deflector arrays so that respective distances from the two light deflector arrays are both equal to the focal length to perform switching by converting the horizontal angle of the light of each wavelength adjusted by one of the light deflector arrays into a horizontal position on another light deflector array.

2. The wavelength cross connect device according to claim 1, wherein the wavelength switching optical system comprises multi-stage Fourier optical lenses acting only in a vertical direction and is configured to convert a vertical angle into a vertical position and subsequently convert the vertical position back into the vertical angle by the multi-stage lenses.

3. The wavelength cross connect device according to claim 1, wherein the input demultiplexing optical system and the output multiplexing optical system comprise:
waveguide arrays being formed by monolithically integrating a plurality of channel waveguides formed on a flat substrate so as to have a structure having a high refractive index core covered with a low refractive index cladding such that input/output ports on one side of the channel waveguides are used as the input ports or the output ports and input/output ports on another side are aligned in a straight line in a widthwise direction; and
a demultiplexing element vertically demultiplexing the light of each port emitted from the input/output port on the other side of the waveguide array into each wavelength and then outputting the demultiplexed lights to the wavelength switching optical system or multiplexing the light of each wavelength input from the wavelength switching optical system and then making the multiplexed light incident on the input/output port on the other side of the waveguide array, and
wherein the lens system comprises:
a first lens comprising a lens acting only in a vertical direction to collimate the light emitted from the input/output port on the other side of the waveguide array and then output the collimated light to the demultiplexing element or to focus the light input from the demultiplexing element and then make the focused light incident on the input/output port on the other side of the waveguide array;
a second lens comprising a lens acting only in a vertical direction to focus the light of each wavelength demultiplexed by the demultiplexing element and then output the focused light to the wavelength switching optical system or to focus the light of each wavelength input from the wavelength switching optical system and output the focused light to the demultiplexing element ; and
a third lens comprising a lens acting only in a widthwise direction and being separately provided in each of the input/output ports on the other side of the waveguide arrays.

4. The wavelength cross connect device according to claim 3, wherein an enlarged-waveguide portion is formed on each of the channel waveguides of the waveguide array, the enlarged-waveguide portion being formed by enlarging the core toward the input/output port on the other side as viewed from the top by using a tapered waveguide or a slab waveguide, and the third lens comprises a bulk cylindrical lens array provided in the vicinity of an output port of the enlarged-waveguide portion.

5. The wavelength cross connect device according to claim 3, wherein an enlarged-waveguide portion is formed on each of the channel waveguides of the waveguide array, the enlarged-waveguide portion being formed by enlarging the core toward the input/output port on the other side as viewed from the top by using a tapered waveguide or a slab waveguide, and the third lens comprises a waveguide lens formed on the core enlarged by the enlarged-waveguide portion of each of the channel waveguides or on a cladding in the vicinity of the enlarged core.

6. The wavelength cross connect device according to claim 5, wherein the waveguide lens is formed by filling a cladding material or a resin having a lower refractive index than the core into a plurality of trenches formed by vertically trenching the core of each of the channel waveguides so that the total width of trenches forms a lens shape or Fresnel lens shape that is concave with respect to a light propagation direction as viewed from the top.

7. The wavelength cross connect device according to claim 6, wherein a resin having a lower refractive index than the cladding is used as the resin having a lower refractive index than the core.

8. The wavelength cross connect device according to claim 5, wherein the waveguide lens is formed by filling a resin having a higher refractive index than the core into a plurality of trenches formed by vertically trenching the core of each of the channel waveguides so that the total width of trenches forms a lens shape or Fresnel lens shape that is convex with respect to a light propagation direction as viewed from the top.

9. The wavelength cross connect device according to claim 6, wherein the plurality of trenches are formed so as to be unequally spaced in a light propagation direction.

10. The wavelength cross connect device according to claim 3, wherein the channel waveguides of the waveguide array each comprise a bent portion formed by bending the core.

11. The wavelength cross connect device according to claim 3, wherein an optical fiber array comprising a plurality of optical fibers arranged in an array manner is connected to the input/output ports on the one side of the waveguide array.

12. The wavelength cross connect device according to claim 3, wherein the demultiplexing element comprises a grating having ruled line formed in a widthwise direction.

13. The wavelength cross connect device according to claim 12, wherein the grating comprises a reflective blazed grating or a reflective echelle grating or a grism comprising a grating and a prism coating a surface thereof.

14. The wavelength cross connect device according to claim 1, wherein the light deflector array is formed by arranging a plurality of strip-shaped one-dimensional MEMS mirror groups in a widthwise direction in an array manner so as to correspond to each port, the plurality of one-dimensional MEMS mirror groups each comprising a plurality of MEMS mirrors one-dimensionally arranged in a vertical direction.

15. The wavelength cross connect device according to claim 14, wherein the MEMS mirrors are each configured such that an interval in an array direction thereof corresponds to a signal frequency interval of not more than 12.5 GHz and a gap between the adjacent MEMS mirrors is set to not more than a spot-size of the incoming light.

16. The wavelength cross connect device according to claim 14, wherein the one-dimensional MEMS mirror group is formed by grouping a plurality of the MEMS mirrors so that the grouped MEMS mirrors are controlled to be inclined at the same angle.

17. The wavelength cross connect device according to claim 1, wherein the light deflector array is formed by arranging a plurality of LCOS chips in a widthwise direction in an array manner so as to correspond to each port.

18. The wavelength cross connect device according to claim 1, wherein the light deflector array comprises an LCOS chip in one-piece and is configured such that the oval-shaped focal point group corresponding to all operating wavelengths output from each port falls within an effective diameter of the LCOS chip.

19. The wavelength cross connect device according to claim 17, wherein the LCOS chip comprises a 114 wavelength layer formed between a liquid crystal layer and a reflective film.
